(19) United States
(12) Patent Application Publication
(10) Pub. No.: US 2013/0282928 A1
(43) Pub. Date: Oct. 24, 2013

(54) WIRELESS ADAPTER FOR CONNECTING A COMPUTING DEVICE DIRECTLY TO A NON-MASTER PERIPHERAL DEVICE WITH LEGACY INTERFACE AND METHOD OF USE

(71) Applicant: Healthmob, Inc., Cambridge, MA (US)

(72) Inventors: Leonid Winestein, Chestnut Hill, MA (US); Emelio Williams, Cambridge, MA (US); Boris Bark, Middletown, NJ (US); Daniel Brateris, Lake Como, NJ (US)

(21) Appl. No.: 13/866,585

(22) Filed: Apr. 19, 2013

Related U.S. Application Data
(60) Provisional application No. 61/635,429, filed on Apr. 19, 2012.

(51) Int. Cl. G06F 3/06; G06F 13/38

(52) U.S. Cl. CPC G06F 3/0659; G06F 13/385
USPC 710/5; 710/63

(57) ABSTRACT

A wireless adapter and method of using the adapter for wireless connection via communication protocols, communication and data exchange between non-master peripheral devices that have legacy interface such as legacy wired serial computer interfaces and computing devices. The wireless adapter includes a wireless module such as a radio transmission/reception module that supports one or more wireless interfaces and has embedded software stack with at least one or several communication protocols. The wireless module is connected to a microprocessor emulating role of a master device. The adapter interface connector plugs into the legacy interface connector of the non-master peripheral device. The microprocessor emulates a master device in legacy interface in combination with a voltage regulator/converter so the wireless adapter plays a role of a master device in legacy interface with the non-master peripheral device acting as a non-master device in interface. This establishes a wireless connection between the computing device and the non-master peripheral device across the wireless adapter.

### RELATED APPLICATIONS

This application claims priority to, and the benefit of, co-pending U.S. Provisional Application No. 61/635,429, filed Apr. 19, 2012, for all subject matter common to both applications. The disclosure of said provisional application is hereby incorporated by reference in its entirety.

### FIELD OF THE INVENTION

The present invention relates to a wireless adapter suitable for connecting with computing devices, and more particularly to a wireless adapter that emulates a master device enabling communication and data exchange between a non-master peripheral device with legacy interface connector and a computing device via the wireless adapter.

### BACKGROUND OF THE INVENTION

The master/slave relations between a host computing device and a slave peripheral device connected through a USB (Universal Serial Bus) interface impedes and affects the functionality of many slave peripheral devices that sometimes have to be physically disconnected from the USB host, execute an operation that the slave peripheral device is designed for, and then be reconnected to the USB host again. Additionally, a USB solution is generally a wired solution.

The wireless Universal Serial Bus (USB) specification has several limitations with respect to the topology design and non-wired solutions. As examples, the wireless USB specification does not generally provide for the following:
1. According to the wireless USB's specification topology design, the design is geared towards using hubs for multiple device connections rather than wireless adapters or dongles. Using a hub multiport universal device does not allow for miniaturization and restricts mobility.
2. Using this standard requires having a computing device with a built-in wireless controller or external hub/controller that supports this wireless standard. This does not allow for mobility and also significantly increases costs of the solution.

Thus, the problems and limitations surrounding use of a USB interface have not been adequately addressed or solved.

### SUMMARY

There is a need for a wireless adapter that has a built in controller and is configured to work with a slave peripheral device with USB interface, for example. The present invention is directed toward further solutions to address this need, in addition to having other desirable characteristics.

The wireless adapter system in accordance with the present invention advantageously allows for increased mobility in a miniaturized form factor through the use of a wireless adapter for a connection to a single non-master peripheral device (e.g., weight scale, heart-rate monitor, glucometer, etc.). This technology enables the pass through of USB connections via a wireless connection, thereby advantageously increasing the mobility of non-master peripheral devices and reducing the production costs of the wireless adapter.

The present invention relates to a wireless adapter, such as a dongle having an adapter interface connector for connecting to non-master peripheral devices, including various household appliances, exercise equipment, medical devices, mobile phones, etc. The present invention also relates to remote device control on the wireless network.

In accordance with an embodiment of the present invention, a wireless adapter for wirelessly connecting a computing device directly to a non-master peripheral device is provided. The wireless adapter has a wireless module configured to support one or more wireless communication protocols for connecting to the computing device. The wireless adapter also has a microprocessor with a master emulator. Also, the wireless adapter has an adapter interface connector configured for electronically coupling the wireless adapter to a legacy interface connector of the non-master peripheral device. The wireless adapter also has a voltage regulator/converter controlled by the microprocessor and configured to connect a battery with the adapter interface connector. When the wireless adapter is coupled with the non-master peripheral device, the master emulator of the microprocessor instructs the voltage regulator/converter to provide about a 5 volt signal from the battery to the adapter interface connector. This causes the wireless adapter to emulate a master device in legacy interface in communication with the non-master peripheral device acting as a slave device in interface in such a way that direct wireless connection is established between the computing device and the non-master peripheral device.

In accordance with aspects of the present invention, the legacy interface connector can be a universal serial bus (USB)-type connector, RS232-type connector, or serial type connector. The adapter interface connector can be a USB-type connector, RS232-type connector, or serial type connector.

In accordance with aspects of the present invention, the non-master peripheral device can be household appliances, exercise equipment, weight scales, heart-rate monitors, medical equipment, consumer devices, and industrial devices. The computing device can be smart phones, tablets, laptops, or personal computers.

In accordance with aspects of the present invention, the one or more wireless communication protocols can be WiFi—IEEE 802.11, Bluetooth—IEEE 802.15.1, ANT, ZigBee—802.15.4, or Global System for Mobile Communications (GSM).

In accordance with aspects of the present invention, the wireless adapter has a serial interface connecting the microprocessor to the wireless module. In particular, the serial interface can be a synchronous serial port interface (SPI), universal asynchronous receiver transmitter (UART), RS-232 serial port, I²C, or universal serial bus (USB).

In accordance with aspects of the present invention, the battery has an electro-chemical re-chargeable battery.

In accordance with aspects of the present invention, the wireless adapter has a voltage regulator connected between the battery, the microprocessor, and the wireless module.

In accordance with aspects of the present invention, the wireless adapter has a battery capacity circuitry connected to the microprocessor and configured to measure a power capacity stored in the battery.

In accordance with aspects of the present invention, the wireless adapter has a battery charging circuitry connected to the battery and configured for charging the battery with an external power source.

In accordance with aspects of the present invention, the wireless adapter has a light-emitting diode (LED) for indicating wireless adapter status and functionality.

In accordance with aspects of the present invention, the microprocessor is a microcontroller RISC unit (MCU).

In accordance with an embodiment of the present invention, a method of using a wireless adapter to wirelessly connect a computing device directly to a non-master peripheral device. The method includes wirelessly connecting the wireless adapter to the computing device. An adapter interface connector of the wireless adapter is electronically coupled to a legacy interface connector of the non-master peripheral device. A voltage regulator/converter of the wireless adapter is instructed, using a microprocessor to emulate a master device in legacy interface, to provide about a 5 volt signal from a battery to the adapter interface connector. The wireless adapter is caused to emulate a master device in legacy interface in communication with the non-master peripheral device acting as a slave device in interface. Direct wireless connection is established between the computing device and the non-master peripheral device.

In accordance with aspects of the present invention, the method further includes receiving a packet of information from the non-master peripheral device to the wireless adapter and responding to the received packet of information.

In accordance with aspects of the present invention, responding to the received packet of information includes forwarding the packet of information to a computing device via wireless communication.

In accordance with aspects of the present invention, the method further includes determining a packet type for the packet of information received from the non-master peripheral device. In a further embodiment, responding to the received packet of information includes executing one or more commands within the received packet of information based on the determination of the packet type. In another further embodiment, at least one command is generated based on the determination of the packet type.

In accordance with aspects of the present invention, the method further includes controlling the non-master peripheral device with the computing device via the wireless adapter.

In accordance with aspects of the present invention, the method further includes setting the wireless adapter into sleep mode to reduce power consumption.

### BRIEF DESCRIPTION OF THE FIGURES

These and other characteristics of the present invention will be more fully understood by reference to the following detailed description in conjunction with the attached drawings, in which:

FIG. 1 is a schematic diagram of a wireless adapter according to an embodiment of the present invention;

FIG. 2 is an exemplary block diagram of a wireless adapter according to one aspect of the present invention;

FIG. 3 is a an exemplary flow diagram of a wireless adapter system according to one aspect of the present invention; and

FIG. 4 is a flowchart diagram of the data flow in a wireless adapter system according to one aspect of the present invention.

### DETAILED DESCRIPTION

An illustrative embodiment of the present invention relates to a wireless adapter and method of using the wireless adapter. The wireless adapter is used with wireless communication protocols (i.e., WiFi—IEEE 802.11, Bluetooth—IEEE 802.15.1, ANT, ZigBee—802.15.4, Global System for Mobile Communications (GSM), etc.) which are utilized in communication and data exchange between non-master peripheral devices and computing devices via the wireless adapter. The non-master peripheral device can take the form of any number of different devices, including but not limited to household appliances, exercise equipment, medical devices, etc. that have legacy interface and connectors such as legacy wired serial computer interfaces (i.e., USB, RS232, etc.). A computing device can be a laptop computer, personal computer, smart phone, tablet or other type that have built-in or external compatible wireless adapters.

As utilized herein, the phrase “non-master” with respect to peripheral devices is intended to convey that the peripheral device does not act as a master device. The present invention can be utilized with USB technology, as well as older, legacy, serial technologies. With the older, legacy, serial technologies, the concept of master/slave was not yet established, as would be appreciated by those of skill in the art. Because the present invention can operate with USB as well as these other serial technologies, the phrase “non-master” is introduced herein to indicate a “slave” USB device, or a non-USB serial device that is not configured to operate as a master device when communicating with the adapter of the present invention (because such peripheral devices are not capable of acting as master devices under the later developed USB protocol).

The wireless adapter includes a wireless module that is a radio transmission/reception module for supporting one or more wireless interfaces and has an embedded software stack with at least one or several communication protocols. The wireless module is connected via one of the serial interfaces (synchronous serial port interface (SPI), Universal Asynchronous Receiver Transmitter (UART) interface, I²C, USB, etc.) to a microprocessor or microcontroller that has loadable non-volatile memory and is configured to instruct an emulation of a wireless adapter as a master role in interface such as master USB or RS232 using an adapter interface connector such as a wire link connector to plug into non-master peripheral devices with legacy interface connectors and legacy serial interfaces.

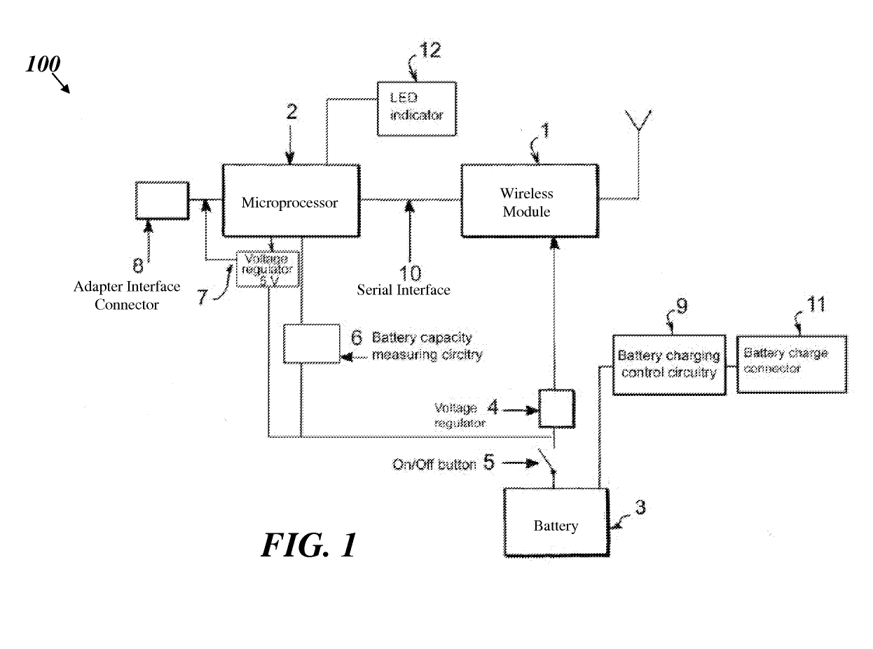

FIGS. 1 through 4, wherein like parts are designated by like reference numerals throughout, illustrate example embodiments of a wireless adapter according to the present invention. Although the present invention will be described with reference to the example embodiment or embodiments illustrated in the figures, it should be understood that many alternative forms can embody the present invention. One of skill in the art will additionally appreciate different ways to alter the parameters of the embodiment(s) disclosed, such as the size, shape, or type of elements or materials, in a manner still in keeping with the spirit and scope of the present invention.

The wireless adapter facilitates a wireless connection of a computing device directly to a non-master peripheral device. The wireless adapter achieves this wireless connection by advantageously simulating personal computer (PC) behavior such as a universal serial bus (USB) connection through a USB host controller that behaves as a master controller in communication with the non-master peripheral devices. This results in the non-master peripheral device operating as though it is communicating with a master interface such as the interface of a conventional personal computer. The wireless adapter can utilize a portion of the transport layer in a smart device, such as for example a smart phone or even remote PC, to simulate the behavior of the master interface or master controller. The other portion of the transport layer can include a wireless module which is a wireless controller, such as, for example, a Bluetooth controller that can include an implementation of a Bluetooth transport software stack as an interface to wirelessly connect to a smart device and a serial interface, for example UART or RS-232, that allows connection from the wireless module to a microprocessor with a host controller such as a USB host controller.

For example, a computing device such as a smart phone or PC can act as a master controller of a non-master peripheral device by wirelessly connecting with the peripheral device through a wireless adapter. In this example, the wireless adapter can emulate the USB host controller by passing commands and data between the non-master peripheral device and a computing device (i.e., playing a role of the wireless-wired “extension cord” that passes commands and data to the non-master peripheral devices from the computing devices such as PC or another smart device without analyzing or interpreting them). In addition, the wireless adapter can pass data and commands from the non-master peripheral devices to the computing device.

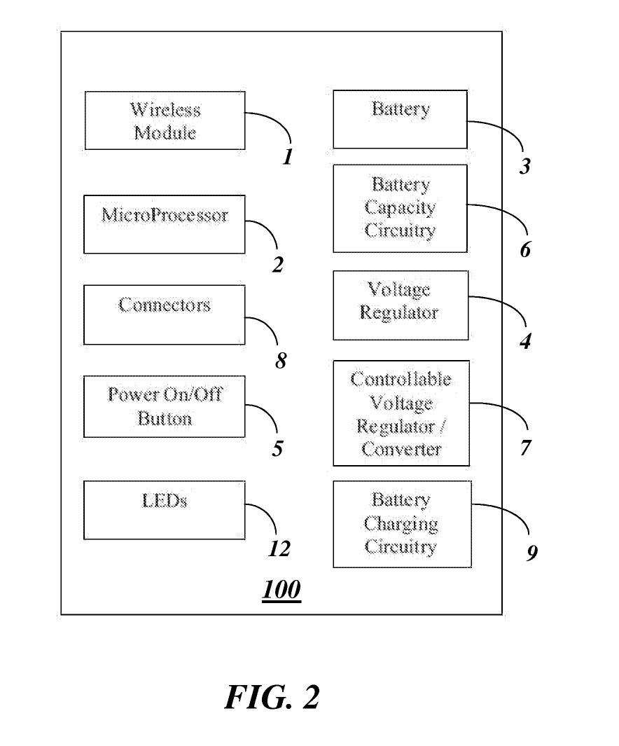

FIG. 1 illustrates a wireless adapter 100 for non-master peripheral devices such as legacy USB and serial interface devices. FIG. 2 illustrates a block diagram of the wireless adapter 100.

The device can include one or more of the following hardware components as shown in FIGS. 1 and 2.

In accordance with the present invention, the wireless module 1 is a wireless radio communication module or wireless controller that supports at least one of the wireless interfaces such as WiFi—IEEE 802.11, Bluetooth—IEEE 802.15.1, ANT, ZigBee—802.15.4, GSM, etc. and allows multiple connections from various computing devices such as a laptop, PC computer, smart phone, tablet or other type of device that has an internal or external compatible wireless adapter. The wireless module 1 additionally has an embedded software stack with one or several communication protocols for each wireless interface.

The wireless adapter 100 includes connectors 8, 11. In FIG. 1, one connector 8 is an adapter interface connector used for connecting the wireless adapter 100 to a non-master peripheral device. This adapter interface connector 8 can be a USB connector or serial connector. The wireless adapter 100 emulates a master role in interface such as a master USB or other master serial legacy interface to connect as a master or host with non-master peripheral devices. Another connector 11 is a battery charge connector for external charging of the wireless adapter 100 battery.

The wireless adapter 100 includes a microprocessor 2. For example, the microprocessor 2 may be a microcontroller RISC unit (MCU) with loadable non-volatile memory (NVM) and random access memory (RAM). Also, the microprocessor 2 is connected to a wireless module 1 via a serial interface 10 such as synchronous serial port interface (SPI), Universal Asynchronous Receiver Transmitter (UART) interface, I²C, USB, etc. The microprocessor 2 is configured to cause the wireless adapter 100 to emulate a master role in legacy interface such as master USB or RS232 (or other similar master legacy serial interface such as master RS422 or RS485).

The wireless adapter 100 includes a battery 3 such as an electro-chemical re-chargeable battery with a voltage regulator 4 and battery charge connector 11 for connecting to an external power adapter to charge the battery 3. The electro-chemical re-chargeable battery may be a lithium ion polymer or other type of re-chargeable battery. The battery 3 is charged in a controlled manner with the battery charging circuitry 9. The wireless adapter 100 can be internally powered requiring the adapter to have its own rechargeable or replaceable battery 3. In this internal example, the wireless adapter 100 may house a battery 3 that is necessary in providing power to the wireless adapter 100. Alternatively, the wireless adapter 100 can be externally powered using power provided by a non-master peripheral device. In this external example, the wireless adapter may be simplified to requiring less components since power is provided from a battery housed within the non-master peripheral device.

The microprocessor 2, specifically MCU, is configured for measuring battery remaining capacity using the battery capacity circuitry 6. When capacity falls below minimal level, the microprocessor 2 generates a command to be sent wirelessly to a computing device and indicates low power alert on the wireless adapter and turns itself off.

The microprocessor 2, specifically MCU, controls a voltage regulator/converter 7 that provides about a 5 volts signal, which is necessary for the wireless adapter 100 to emulate a master role in the interface such as USB interface. The voltage regulator/converter 7 is MCU-controlled to enable and disable connection to the non-master peripheral device, to reduce battery power consumption, and possibly allow a non-master peripheral device for taking a measurement.

The wireless adapter 100 includes a manual power button 5 or an electronic switch for turning On and Off the wireless adapter 100 to extend the battery life of the adapter.

The wireless adapter 100 includes light-emitting diodes (LEDs) 12 such as a multi-color light-emitting diode (LED) which indicate a variety of wireless adapter statuses and functionalities such as communications between a non-master peripheral device and a computing device. In an alternative example, a display may be used as an indicator.

In general, the wireless adapter 100 may include the following features:
a). a wireless module 1 with embedded software stack that supports at least one wireless communication protocol that enables controlled communication between the non-master peripheral device and the computing device; and
b). a microprocessor 2, such as the MCU, with loadable NVM and RAM, one connector such as a serial interface 10 for connecting the wireless module 1 to the microprocessor 2, and an adapter interface connector 8 such as a legacy interface connector, USB, or serial RS232, etc. to connect to a non-master peripheral device.

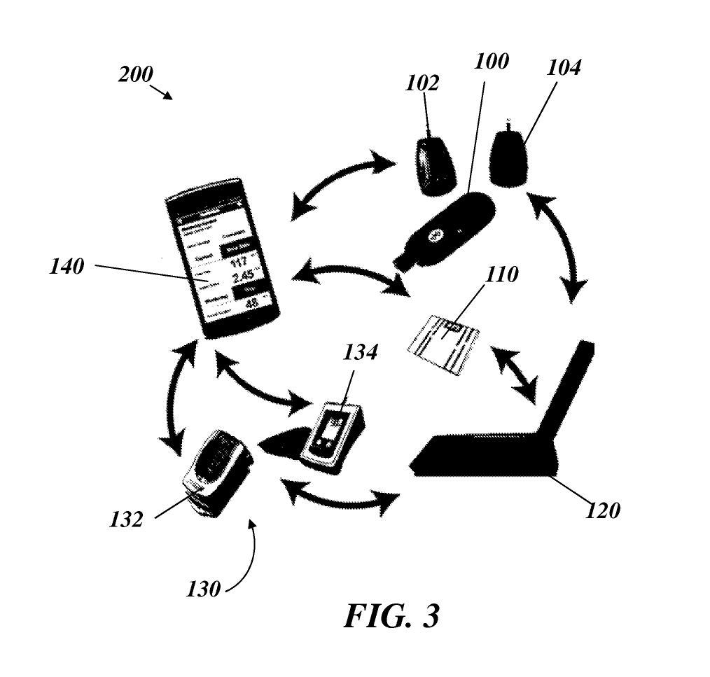

FIG. 3 illustrates a data flow diagram of the wireless adapter system 200. The wireless adapter system 200 includes a wireless adapter 100 such as a miniature dongle for connecting non-master peripheral devices with computing devices. The wireless adapter 100 emulating a master device in legacy such as USB or serial RS232, UART, etc. interfaces. This enables wireless communication between computing devices and non-master peripheral devices via the wireless adapter 100. As shown in FIG. 3, the non-master peripheral devices may include USB 2.0 or serial devices such as a glucometer 102, lactatemeter 104, scale 110, and native Bluetooth devices 130. The native Bluetooth devices 130 may include a pulse oximeter 132 or blood pressure/glucometer 134. Other non-master peripheral devices may be used as known by one of skill in the art. Computing devices may include Bluetooth enabled personal computers/laptops 120 and smartphones 140. Other computing devices may be used as known by one of skill in the art.

The microprocessor 2, such as MCU, is configured to facilitate bi-directional communication with at least one non-master peripheral device through an adapter interface connector 8 such as USB or serial plugged into a device connector interface. The microprocessor 2 (MCU) in combination with the voltage regulator/converter 7 causes the wireless adapter 100 to emulate a master role in legacy interface such as USB or other serial interface RS232, UART, etc. and bi-directional wireless communication via the wireless module 1 to an associated computing device. Non-master peripheral device commands and data as well as the wireless adapter or dongle commands processed by the microprocessor 2 are sent to or received from a non-master peripheral device or computing device. The microprocessor 2 determines what type of packet of information is received from a computing device or non-master peripheral device.

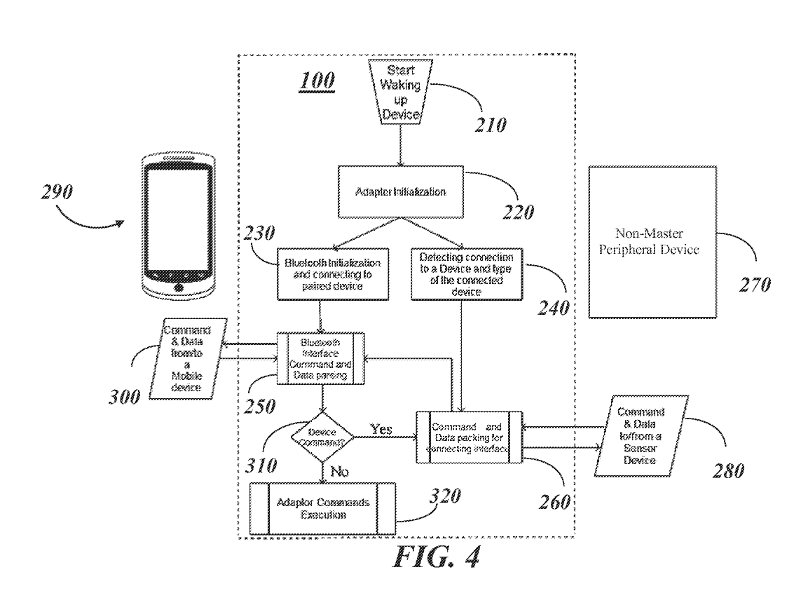

As shown in FIG. 4, the microprocessor either interprets the packet of information and executes a command using device command logic 310 if it is a wireless adapter command (for example, to shut off 5 V power to the non-master peripheral device 270 or low battery warning), or lets the non-master peripheral device 270 command and data pass without any modification. The distinction between the non-master peripheral device commands, the computing device commands, and the wireless adapter commands is necessary because they are executed by different components of the wireless adapter and the commands have to be directed properly to a non-master peripheral device 270, computing device 290, or the wireless adapter accordingly. For example, the wireless adapter differentiates between non-master peripheral device commands/data and its own commands and either passes the non-master peripheral device commands/data to a computing device that is connected to the wireless adapter or the wireless adapter executes its own commands.

The NVM is used to store important data such as, for example, passwords that allow a user to restrict access to the non-master peripheral device 270 and/or state or status of the device if a non-master peripheral device 270 has several different profiles. The RAM is used for MCU processing, data buffering, and other temporary storage.

The wireless adapter 100 combines the microprocessor 2 (particularly MCU), that can emulate a master device in a legacy interface such as USB or serial RS232 etc., with the wireless module 1 that has embedded at least one software stack and communication protocol for connecting a non-master peripheral device 270 with a computing device. Additionally, the microprocessor 2 controls the electro-chemical battery 3 and voltage regulator/converter 7 utilized to emulate a master interface and power management.

FIG. 4 illustrates one example methodology for using the wireless adapter 100 depicted in a flow chart. In step 210, a user starts by activating the wireless adapter 100. This causes initialization of the wireless adapter 100 (step 220). The initialization of the wireless adapter 100 leads to both Bluetooth initialization for connecting to a computing device 290 (step 230) and detecting a connection to a non-master peripheral device 270 and type of connected non-master peripheral device 270 (step 240). From step 230 (Bluetooth Initialization), step 250 includes Bluetooth interface command and data parsing. From step 240 (detecting connection to non-master peripheral device 270), step 260 includes command and data packing for connecting to a legacy interface connector. After step 260, the wireless adapter 100 may connect to a non-master peripheral device 270 such as a sensor device by command & data to/from the non-master peripheral device 270 (step 280). Alternatively, step 260 leads to Bluetooth interface command and data parsing (step 250). Bluetooth interface command and data parsing (step 250) may connect to a computing device 290 such as a mobile device by command & data from/to the mobile device (step 300). Alternatively, from step 250 (Bluetooth interface command and data parsing), a device command logic (step 310) may be initiated. If an answer to the device command logic is “Yes,” the flow chart leads back to step 260 (command and data packing for sending to legacy interface connector). If the answer to the device command logic is “No,” the wireless adapter executes its own commands (step 320).

To use the wireless adapter system 200, a user connects or plugs (depending on the connector design) the wireless adapter 100 into a legacy non-master peripheral device 270 and turns the wireless adapter 100 on. After connection, the user establishes and configures a wireless connection between the wireless adapter 100 and computing device 290 via the Adapter & Bluetooth initializations (steps 220 and 230) shown in FIG. 4. Simultaneously on the non-master peripheral device side, the wireless adapter 100 via USB or serial interface detects a connected non-master peripheral device 270 and determines whether the non-master peripheral device 270 is a supported device. In particular, step 240 includes detecting connection to a non-master peripheral device 270 and type of connected non-master peripheral device 270. If the wireless adapter connects to an unsupported non-master peripheral device 270, it will generate a message to the computing device 290 indicating that the connected non-master peripheral device 270 is unknown. Communication between the computing device 290 and connected non-master peripheral device 270 is done with software that directly sends commands to the wireless adapter 100 using wireless interface and protocol or could be a non-master peripheral device driver that has wireless capability.

In one example, the wireless adapter system 200 includes a wireless adapter 100 for non-master peripheral devices 270. The wireless adapter 100 includes a wireless module 1 configured to communicate with a computing device 290 via an embedded software stack that supports at least one wireless protocol that enables controlled communication between the wireless adapter 100 and a computing device 290; and a microprocessor 2 in combination with the voltage regulator/converter 7 is configured to cause the wireless adapter 100 to emulate a master device in legacy interface and to connect with a non-master peripheral device 270, acting as a slave device in interface, from the adapter interface connector 8 through the legacy interface connector.

In some examples, the non-master peripheral device 270 provides power from the non-master peripheral device battery to the wireless adapter 100 using an electronic power switch instead of a manual power button 5. In these examples, the wireless adapter 100 does not need to include a battery 3, a battery charging circuitry 9, a battery capacity circuitry 6, and/or the manual power button 5. In other examples, the wireless module 100 can go into sleep mode after an idle period (e.g., pre- determined idle period, dynamically determined idle period, etc.) and can be woken up by a command from a non-master peripheral device 270 or computing device 290. Alternatively or additionally, the wireless module can buffer data as another way to reduce power consumption of a battery and extend battery life. The remaining components and/or functionality of the wireless adapter system 200, including the method for wirelessly connecting to a non-master peripheral device 270, can operate the same as described herein.

In some examples, the technology includes a method for wirelessly connecting to a non-master peripheral device 270. The method includes receiving, via an adapter interface connector 8, a communication as a packet of information (e.g., USB packet, serial packet, etc.) from a non-master peripheral device 270; determining a packet type for the packet of information (e.g., dongle command, data packet, etc.); forwarding the communication of the packet of information to a computing device 290 based on the determination of the packet type (e.g., not a dongle command, data directed to the computing device 290, etc.).

In other examples, the method further includes executing a command in the packet of information based on the determination of the packet type (e.g., dongle command, battery power dongle command, etc.).

In other examples, the technology includes a wireless adapter 100 for non-master peripheral devices 270. The wireless adapter 100 includes a wireless module 1 configured to communicate with a computing device 290 via an embedded wireless interface stack, the embedded software stack supports at least one wireless protocol that enables controlled communication between a non-master peripheral device 270 and a computing device 290; and a microprocessor 2 that has a legacy serial interface 10 configured to connect to the wireless module and at least one more adapter interface connector configured to connect to the non-master peripheral device 270. The microprocessor 2 in combination with the voltage regulator/converter 7 is configured to cause the wireless adapter 100 to emulate a master device in legacy interface and to connect with the non-master peripheral device 270 acting as a slave in interface.

In some examples, the wireless adapter system 200 includes a method for wirelessly connecting to a non-master peripheral device 270. The method includes determining a packet type for the communication of the packet of information; forwarding and receiving a wireless communication including the packet of information to/from a computing device 290 based on the determination of the packet type; and receiving or sending, via a serial legacy interface, the communication to/from a non-master peripheral device 270.

In other examples, the method further includes executing or generating a command in the communication based on the determination of the packet type.

The above-described systems and methods can be implemented in digital electronic circuitry, in computer hardware, firmware, and/or software. The implementation can be as a computer program product. The implementation can, for example, be in a machine-readable storage device, for execution by, or to control the operation of, data processing apparatus. The implementation can, for example, be a programmable processor, a computer, and/or multiple computers.

A computer program can be written in any form of programming language, including compiled and/or interpreted languages, and the computer program can be deployed in any form, including as a stand-alone program or as a subroutine, element, and/or other unit suitable for use in a computing environment. A computer program can be deployed to be executed on one computer or on multiple computers at one site.

As shown in FIG. 4, method steps can be performed by one or more programmable processors executing a computer program to perform functions of the invention by operating on input data and generating output. Method steps can also be performed by an apparatus can be implemented as special purpose logic circuitry. The circuitry can, for example, be a FPGA (field programmable gate array) and/or an ASIC (application-specific integrated circuit). Subroutines and software agents can refer to portions of the computer program, the processor, the special circuitry, software, and/or hardware that implement that functionality.

Processors suitable for the execution of a computer program include, by way of example, both general and special purpose microprocessors, and any one or more processors of any kind of digital computer. Generally, a processor receives instructions and data from a read-only memory or a random access memory or both. The essential elements of a computer are a processor for executing instructions and one or more memory devices for storing instructions and data. Generally, a computer can be operatively coupled to receive data from and/or transfer data to one or more mass storage devices for storing data (e.g., magnetic, magneto-optical disks, or optical disks).

Data transmission and instructions can also occur over a communications network. Computer program products suitable for embodying computer program instructions and data include all forms of non-volatile memory, including by way of example semiconductor memory devices. The computer program products can, for example, be EPROM, EEPROM, flash memory devices, magnetic disks, internal hard disks, removable disks, magneto-optical disks, CD-ROM, and/or DVD-ROM disks. The processor and the memory can be supplemented by, and/or incorporated in special purpose logic circuitry.

To provide for interaction with a user, the above described techniques can be implemented on a computer having a display device rather than an LED. The display device can, for example, be a cathode ray tube (CRT), a liquid crystal display (LCD) monitor, or any other form of display. The interaction with a user can, for example, be a display of information to the user and a keyboard and a pointing device (e.g., a mouse or a trackball) by which the user can provide input to the computer (e.g., interact with a user interface element). Other kinds of devices can be used to provide for interaction with a user. Other devices can, for example, be feedback provided to the user in any form of sensory feedback (e.g., visual feedback, auditory feedback, or tactile feedback). Input from the user can, for example, be received in any form, including acoustic, speech, and/or tactile input.

Packet-based networks can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), 802.11 network, 802.16 network, general packet radio service (GPRS) network, HiperLAN, and/or other packet-based networks. Circuit-based networks can include, for example, the public switched telephone network (PSTN), a private branch exchange (PBX), a wireless network (e.g., RAN, Bluetooth, code-division multiple access (CDMA) network, time division multiple access (TDMA) network, global system for mobile communications (GSM) network), and/or other circuit-based networks.

The computing device 290 can include, for example, a computer, a computer with a browser device, a telephone, an IP phone, a mobile device (e.g., cellular phone, personal digital assistant (PDA) device, laptop computer, electronic mail device), and/or other communication devices. The browser device includes, for example, a computer (e.g., desktop computer, laptop computer) with a World Wide Web browser (e.g., Microsoft® Internet Explorer® available from Microsoft Corporation, Mozilla® Firefox available from Mozilla Corporation). The mobile computing device 290 includes, for example, any form of smartphone.

Numerous modifications and alternative embodiments of the present invention will be apparent to those skilled in the art in view of the foregoing description. Accordingly, this description is to be construed as illustrative only and is for the purpose of teaching those skilled in the art the best mode for carrying out the present invention. Details of the structure may vary substantially without departing from the spirit of the present invention, and exclusive use of all modifications that come within the scope of the appended claims is reserved. Within this specification embodiments have been described in a way which enables a clear and concise specification to be written, but it is intended and will be appreciated that embodiments may be variously combined or separated without parting from the invention. It is intended that the present invention be limited only to the extent required by the appended claims and the applicable rules of law.

It is also to be understood that the following claims are to cover all generic and specific features of the invention described herein, and all statements of the scope of the invention which, as a matter of language, might be said to fall therebetween.

What is claimed is:

1. A wireless adapter for wirelessly connecting a computing device directly to a non-master peripheral device, the wireless adapter comprising:
a wireless module configured to support one or more wireless communication protocols for connecting to the computing device;
a microprocessor having a master emulator;
an adapter interface connector configured for electronically coupling the wireless adapter to a legacy interface connector of the non-master peripheral device; and
a voltage regulator/converter controlled by the microprocessor and configured to connect a battery with the adapter interface connector;
wherein when the wireless adapter is coupled with the non-master peripheral device the master emulator of the microprocessor instructs the voltage regulator/converter to provide about a 5 volts signal from the battery to the adapter interface connector, causing the wireless adapter to emulate a master device in legacy interface in communication with the non-master peripheral device acting as a slave device in interface, in such a way that direct wireless connection is established between the computing device and the non-master peripheral device.

2. The wireless adapter of claim 1, wherein the legacy interface connector is selected from the group consisting of a universal serial bus (USB)-type connector, RS232-type connector, and serial type connector.

3. The wireless adapter of claim 1, wherein the adapter interface connector is selected from the group consisting of USB-type connector, RS232-type connector, and serial type connector.

4. The wireless adapter of claim 1, wherein the non-master peripheral device is selected from the group consisting of household appliances, exercise equipment, weight scales, heart-rate monitors, medical equipment, consumer devices, and industrial devices.

5. The wireless adapter of claim 1, wherein the computing device is selected from the group consisting of smart phones, tablets, laptops, and personal computers.

6. The wireless adapter of claim 1, wherein the one or more wireless communication protocols are selected from the group consisting of WiFi—IEEE 802.11, Bluetooth—IEEE 802.15.1, ANT, ZigBee—802.15.4, and Global System for Mobile Communications (GSM).

7. The wireless adapter of claim 1, further comprising a serial interface connecting the microprocessor to the wireless module.

8. The wireless adapter of claim 7, wherein the serial interface is selected from the group consisting of synchronous serial port interface (SPI), universal asynchronous receiver transmitter (UART), RS-232 serial port, I²C, and universal serial bus (USB).

9. The wireless adapter of claim 1, wherein the battery comprises an electro-chemical re-chargeable battery.

10. The wireless adapter of claim 1, further comprising a voltage regulator connected between the battery, the microprocessor, and the wireless module.

11. The wireless adapter of claim 1, further comprising a battery capacity circuitry connected to the microprocessor and configured to measure a power capacity stored in the battery.

12. The wireless adapter of claim 1, further comprising a battery charging circuitry connected to the battery and configured for charging the battery with an external power source.

13. The wireless adapter of claim 1, further comprising a light-emitting diode (LED) for indicating wireless adapter status and functionality.

14. The wireless adapter of claim 1, wherein the microprocessor is a microcontroller RISC unit (MCU).

15. A method of using a wireless adapter to wirelessly connect a computing device directly to a non-master peripheral device, the method comprising:
wirelessly connecting the wireless adapter to the computing device;
electronically coupling an adapter interface connector of the wireless adapter to a legacy interface connector of the non-master peripheral device;
instructing, using a microprocessor to emulate master device in legacy interface, a voltage regulator/converter of the wireless adapter to provide about a 5 volts signal from a battery to the adapter interface connector;
causing the wireless adapter to emulate a master device in legacy interface in communication with the non-master peripheral device acting as a slave device in interface; and
establishing direct wireless connection between the computing device and the non-master peripheral device.

16. The method of claim 15, further comprising:
receiving a packet of information from the non-master peripheral device to the wireless adapter; and
responding to the received packet of information.

17. The method of claim 16, wherein responding to the received packet of information further comprises forwarding the packet of information to a computing device via wireless communication.

18. The method of claim 16, further comprising determining a packet type for the packet of information received from the non-master peripheral device.

19. The method of claim 18, wherein responding to the received packet of information further comprises executing one or more commands within the received packet of information based on the determination of the packet type.

20. The method of claim 19, further comprising generating at least one command based on the determination of the packet type.

21. The method of claim 15, further comprising controlling the non-master peripheral device with the computing device via the wireless adapter.

22. The method of claim 15, further comprising setting the wireless adapter into sleep mode to reduce power consumption.
